(19) United States
(12) Patent Application Publication
(10) Pub. No.: US 2020/0146487 A1
(43) Pub. Date: May 14, 2020

(54) SYSTEMS AND METHODS FOR MAKING CUSTOMIZED CLOTHING HANGERS

(71) Applicant: Bespoke Brands LLC, Milwaukee, WI (US)

(72) Inventor: Reuben Luria, Milwaukee, WI (US)

(73) Assignee: Bespoke Brands LLC, Milwaukee, WI (US)

(21) Appl. No.: 16/743,633

(22) Filed: Jan. 15, 2020

Related U.S. Application Data
(63) Continuation of application No. PCT/US2019/041918, filed on Jul. 16, 2019.
(60) Provisional application No. 62/772,183, filed on Nov. 28, 2018.
(60) Provisional application No. 62/698,525, filed on Jul. 16, 2018.

(51) Int. Cl. A47G 25/28; H04N 5/225

(52) U.S. Cl. CPC A47G 25/28; H04N 5/225

(57) ABSTRACT

A method for creating a customized clothing hanger. The method includes receiving garment data relating to a garment to be hung on the hanger, and receiving sizing data relating to a consumer, where the garment is wearable by the consumer. The method further includes developing a hanger blueprint based on the garment data and the sizing data, and creating the hanger according to the hanger blueprint.

### CROSS REFERENCE TO RELATED APPLICATIONS

The present application is based on and claims priority to U.S. Provisional Patent Application Ser. No. 62/698,525, filed Jul. 16, 2018, and U.S. Provisional Patent Application Ser. No. 62/772,183, filed Nov. 28, 2019, the disclosures of which are incorporated herein by reference.

### FIELD

The present disclosure generally relates to systems and methods for making customized clothing hangers, and more particularly to systems and methods for making clothing hangers customized based on garment and consumer data.

### BACKGROUND

The Background and Summary are provided to introduce a foundation and selection of concepts that are further described below in the Detailed Description. The Background and Summary are not intended to identify key or essential features of the potentially claimed subject matter, nor are they intended to be used as an aid in limiting the scope of the potentially claimed subject matter.

### SUMMARY

One embodiment according to the present disclosure generally relates to a method for creating a customized clothing hanger. The method includes receiving garment data relating to a garment to be hung on the hanger, and receiving sizing data relating to a consumer, where the garment is wearable by the consumer. The method further includes developing a hanger blueprint based on the garment data and the sizing data, and creating the hanger according to the hanger blueprint.

Another embodiment according to the present disclosure generally relates to a system for creating a customized clothing hanger based on requirements of a consumer. The system includes a bar hook configured to hangingly support the hanger, a hanger neck configured to be coupled to the bar hook, and hanger shoulders each configured to be coupled to the hanger neck. The bar hook, the hanger neck, and the hanger shoulders are modular components selected such that when subsequently assembled they form a hanger that meets the requirements of the consumer.

Another embodiment according to the present disclosure generally relates to a customized clothing hanger for hanging a garment based on a consumer neck size and a consumer shoulder size of a consumer. The hanger includes a hanger neck configured to be coupled to a bar hook for hanging the hanger neck, where the hanger neck defines a cutaway therein such that the hanger is nestable with other like hangers. Two hanger shoulders each extending from to the hanger neck, where a hanger shoulder size is defined as the span between the two hanger shoulders when coupled to the hanger neck, and where the hanger neck and the two hanger shoulders are configured such that the hanger shoulder size corresponds to the consumer shoulder size. A collar support extends forward and above the two hanger shoulders and has a left side and a right side, where a collar span is defined between the left side and the right side of the collar support, and where the collar support is configured such that the collar span corresponds to the consumer neck side.

### BRIEF DESCRIPTION OF THE DRAWINGS

The drawings illustrate embodiments for carrying out the disclosure. The same numbers are used throughout the drawings to reference like features and like components. In the drawings:

FIG. 1 is an isometric view of a customized clothing hanger according to the present disclosure;

FIGS. 2 and 3 depict side and top views of an alternate embodiment of a customized clothing hanger according to the present disclosure;

FIGS. 4-6 depict exemplary process flows for making a customized clothing hanger according to the present disclosure;

FIG. 7 depicts an exemplary system configured to make a customized clothing hanger according to the present disclosure, such as by executing the process flows depicted in FIGS. 4-6;

FIGS. 8 and 9 are an isometric and top views of an alternate embodiment similar to FIG. 1, incorporating a collar support;

FIGS. 10-12 are partial top views of further embodiments of collar supports according to the present disclosure;

FIG. 13 is a partial side view of the embodiment shown in FIG. 12;

FIGS. 14A-14B are isometric and side views of a further embodiment according to the present disclosure;

FIGS. 15A-16 are depict hangers similar to that shown in FIGS. 14A-14B in use with various types of shirts;

FIG. 17 depicts a further embodiment according to the present disclosure configured to provide nesting of adjacent hangers having alternating heights;

FIG. 18 depicts an alternate embodiment similar to FIG. 18 providing nesting of adjacent hangers having the same heights;

FIG. 19 depicts an exemplary sizing system for configuring a modular hanger to meet the sizing requirements of a consumer; and

FIGS. 20A-20B depict an exemplary accessory anchor system for customizing hangers according to the present disclosure.

### DETAILED DISCLOSURE

This written description uses examples to disclose embodiments of the present application and also to enable any person skilled in the art to practice or make and use the same. The patentable scope of the invention is defined by the potential claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Many aspects of the condition of clothing, including both presentation and long term preservation, are dependent upon various characteristics of the clothing storage medium. For example, the warping of a shirt collar, the structural preservation of a garment's shape, the condition of the fabric in the shoulder region, fabric denting, fabric drape, fabric creases, and fabric wrinkling are all affected by the characteristics of the clothing hanger used for its storage. Many of these issues relate to the particular fit of the clothing hanger to the particular garment being hung, as well as considerations for garment characteristics and fabric type, and also the fit of the clothing hanger relative to the garment wearer.

Additionally, consumers have a near-infinite selection of physical characteristics, pairings, and aesthetic preferences for the selection of garments, including material, style, size, and color. However, the present inventor has identified that the same is not true with regard to the clothing hangers used for the storage of these garments. In particular, traditional manufacturing techniques and clothing hangers known in the art do not address the specific physical, aesthetic, and customizable choices both desired by consumers, and necessary for the proper storage of these highly-variable (and often valuable) garments. The world is no longer “one size fits all,” whether in size or style.

The systems and methods of the present disclosure provide for customized clothes hangers, either as complete units or assemblies of modular components. For example, the present systems and methods provide an essential product feature whereby customers' neck sizes can be independently matched with their shoulder sizes and/or independently matched with their waist sizes. One shirt hanger customer might have a 14″ neck and 16″ shoulder size or span, while a second customer has the same 14″ neck size, but broader 18″ shoulders. Clearly, these two customers require different shirt hangers to fit their bodies and clothing accordingly. However, the present inventor has identified that no systems or methods known in the part presently make this customization possible.

Another example is two suit hanger customers who each have the same neck and shoulder size, but one has a 30″ waist and the other a 34″ waist. Though these two customers require the same sized suit hanger “body.” However, a different sized pants bar is required to accommodate their different pants sizes. As will become apparent below, providing an undersized pants bar for the consumer with the 34″ waist will result in wrinkling or bunching of the pants due to inadequate spacing on the pants bar. Likewise, providing an excessively long pants bar that will fit “most” consumers has consequences for those with smaller waists. In particular, the excess space of the pants bar permits excessive movement of the pants on the pants bar, allowing the pants to hang skewed (or slip off the pants bar entirely) from small movements of the clothes hanger.

In addition to waist size, style choices and the particular dimensions of a given garment must also be considered. For example, the 34″ waist customer might have a consumer preference for only skinny cut pants, and therefore would ultimately select the same size pants bar as the 30″ waist size customer despite having a larger waist. In recognition of these unmet needs, the presently disclosed systems and methods accommodate all of these cases and more, as well as accommodating other accessories, options, and consumer preferences.

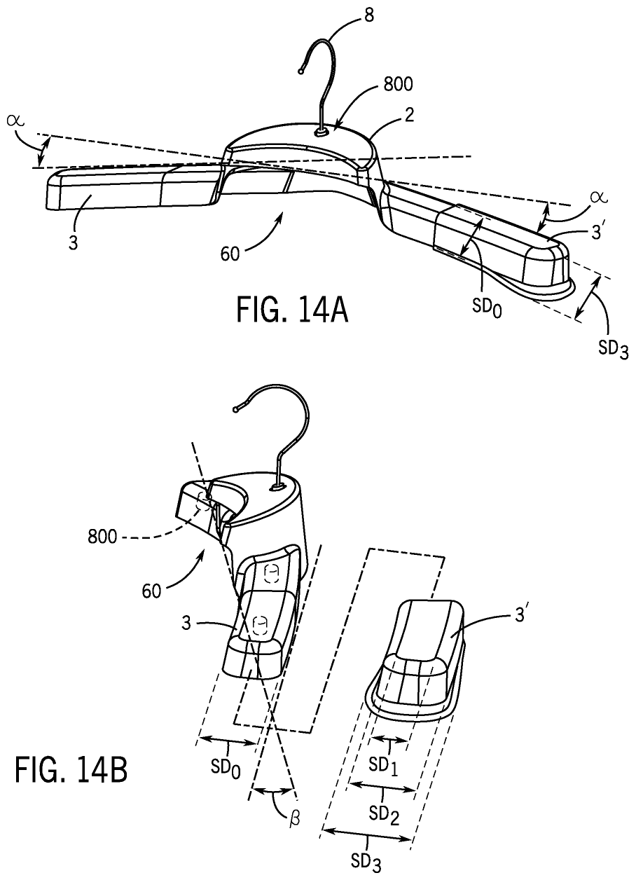

A custom clothing hanger according to the present disclosure may be created through mix and match use of pre-fabricated modular components (for example, being available in 1″ increments), or as a fully-custom construction. In either case, the present disclosure further provides for systems and methods incorporating the required hardware and software to acquire the necessary data and generate the blueprint for the custom clothing hanger required. As will be discussed further below, the software disclosed herein enables the creation of the physical clothing hanger tailored to a given customer's biometric data, such as through acquisition by 3-D cameras. In this manner, the custom clothing hanger may account for every curve of the consumer's body, including any differences in posture and the like. For example, these may include curves and angles α in the vertical plane (i.e., a shoulder drop towards the ground) and/or curves and angles β in the front/back plane (i.e., a forward curve away from the consumer's spine), see FIGS. 14A-B). However, improved accuracy and simplicity are also enabled by the software for using pre-fabricated components, which takes the guesswork out of pairing components and reduces measurement error, among other benefits.

An exemplary embodiment of software incorporates data acquired from a 3-D scanner, which the software uses to create a 3-D computer model of a person's neck, torso and/or lower body. This data, along with customer preferences data, specific garment data, and 3-D production tolerances and limitations data (if required) are then used to develop an exact blueprint for the creation of a customized clothes hanger specifically fitted to the 3-D model. This blueprint may then be used to 3-D print the aforementioned hanger, or to provide as instructions for creating the hanger through other production methods (such as milling a block of wood, for example), or to create one or more custom lasts for making a customized clothes hanger.

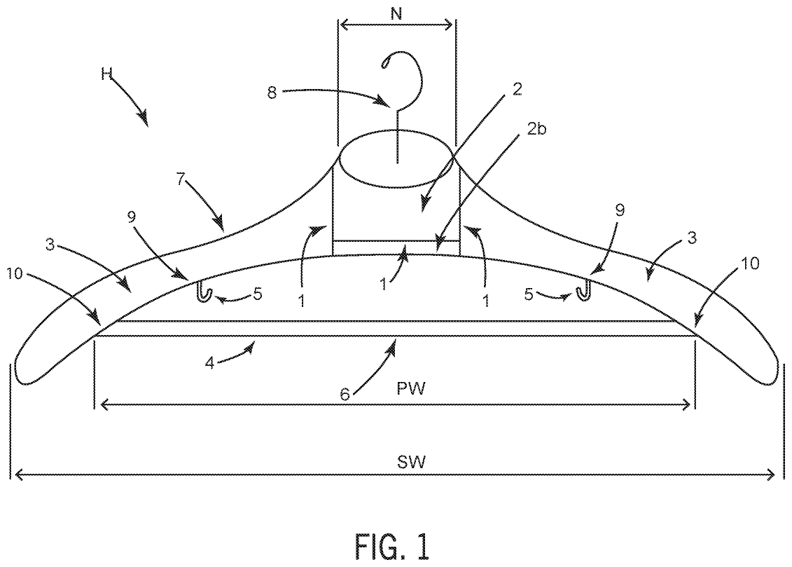

FIG. 1 depicts an isometric view of an exemplary customized clothing hanger H according to the present disclosure. The hanger H includes a hanger neck 2, hanger shoulders 3, and in certain embodiments a hanger pants bar 4, which may be a single bar, multi-bars, contoured surface, or other types of hanging accessories (for example, but not limited to, belts, neck ties, scarves, etc.) known in the art. It is important to note that the hanger neck 2 and hanger shoulder 3 refer to the hanger H and need not correspond to the neck and/or shoulder of the consumer, for example in the case of a pants-only hanger. A bar hook 8 is coupled to the hanger neck 2, either in the customary manner, or as a modular addition discussed further below. Similarly, other types of bar hooks 8 are also anticipated, such as those in which an upper portion remains fixed on a row (i.e., in a hotel), is retained within luggage, and/or the like. In contrast to clothing hangers presently known in the art, FIG. 1 depicts a clothing hanger H having modularity to permit customization based on the needs and style choices of the consumer, and/or the garment to be hung.

In the embodiment shown, the hanger H has a plurality of neck joints 1 in which the hanger neck 2 may be coupled to an appropriately selected hanger shoulder 3 in accordance with the needs of the consumer and/or the garment. In the present embodiment, the joints 21 between the hanger neck 2 and the hanger shoulders 3 are top/down or forward/backward sliding dovetail joints (also known as a locking dado). The joint 1 below the hanger neck 2 locks the hanger shoulders 3 in place with additional sliding dovetail joints between a lock 2b and the hanger shoulders 3 and also the hanger neck 2.

Other exemplary joints 1 known in the art include splices laps, tongue and groove, and others, which may be mitered, cross, and/or dovetailed, for example. It should further be recognized that these joints 1 may be locking and removable or non-removable, may be threaded, may require additional fasteners (such as screws, tacks, and/or the like) and/or may incorporate adhesives, for example.

Accessory joints 9, which in certain embodiments use the accessory anchor system 800 discussed below, are also provided at various locations on the hanger neck 2, hanger shoulders 3, or elsewhere on the hanger H, which provide temporary and/or permanent coupling of accessories 5 thereto. Non-limiting examples of accessories 5 include strap hangers (i.e., for dresses or camisoles), accessory hooks, additional pants bars, belt hangers, and tie hangers. Likewise, the present embodiment includes a plurality of pants bar joints 10 for optionally coupling a selected pants bar 4 to the hanger H, such as to the hanger shoulders 3. In the embodiment shown, the pants bar 4 is customizable to select a pants width PW appropriate for the consumer and/or garment. Similarly, the hanger neck 2 is customizable to have the appropriate neck size N, once again based on consumer and garment preferences and needs. It should be noted that while the neck size N (shown here as the width of the hanger neck 2) is correlated to the consumer's neck circumference, the hanger neck 2 need not have this same circumference (i.e., particularly in cases having a notch 60 defined therein, which is discussed below). Through the selection of the hanger neck 2 and the hanger shoulders 3, either of which may be further subdivided into additional segments having additional joints, the clothing hanger H is customizable to have the necessary shoulder width SW spanning across both the hanger shoulders 3. While the foregoing principally describes customizing for shoulder width SW, the same shall be understood as also applying to shoulder depth SD (also shown as SD0), for example. As discussed above, the shoulder width SW and/or shoulder depth SD0 refer to the hanger shoulder 3, which need not correspond to the shoulder of a consumer. It should also be recognized that the hanger neck 2 could also be integrated into one of the hanger shoulders 3, or formed by the combination of two hanger shoulders 3, for example.

In the embodiment shown, the clothing hanger H is further customizable with respect to materials, which may include natural materials 6 (i.e., wood, bone), man-made materials 7, such as plastics, or a combination thereof as presently shown. Surface treatments (i.e., non-slip texture) or wrappings (i.e., felt or leather) are also anticipated.

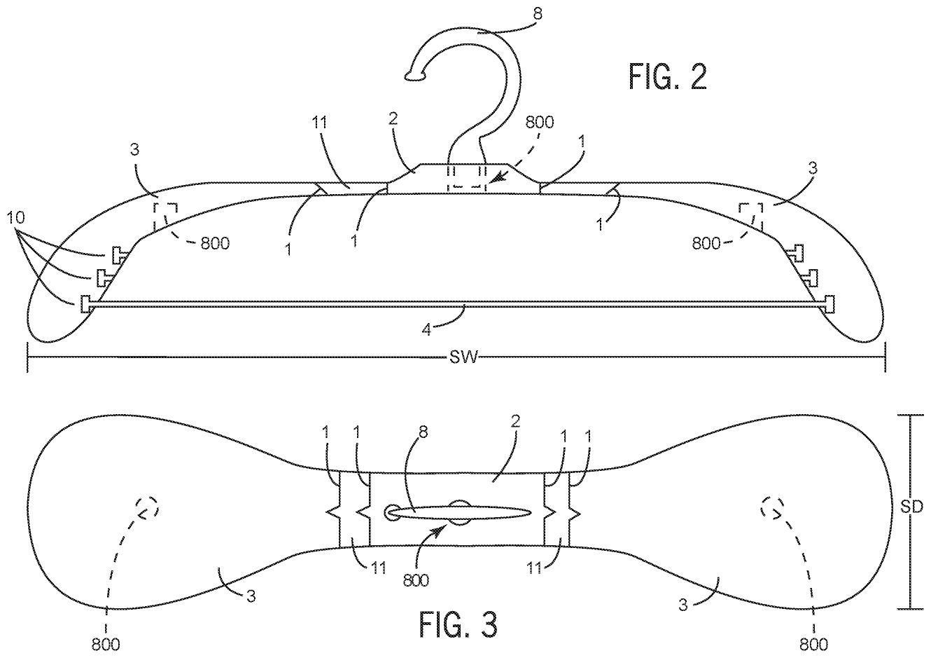

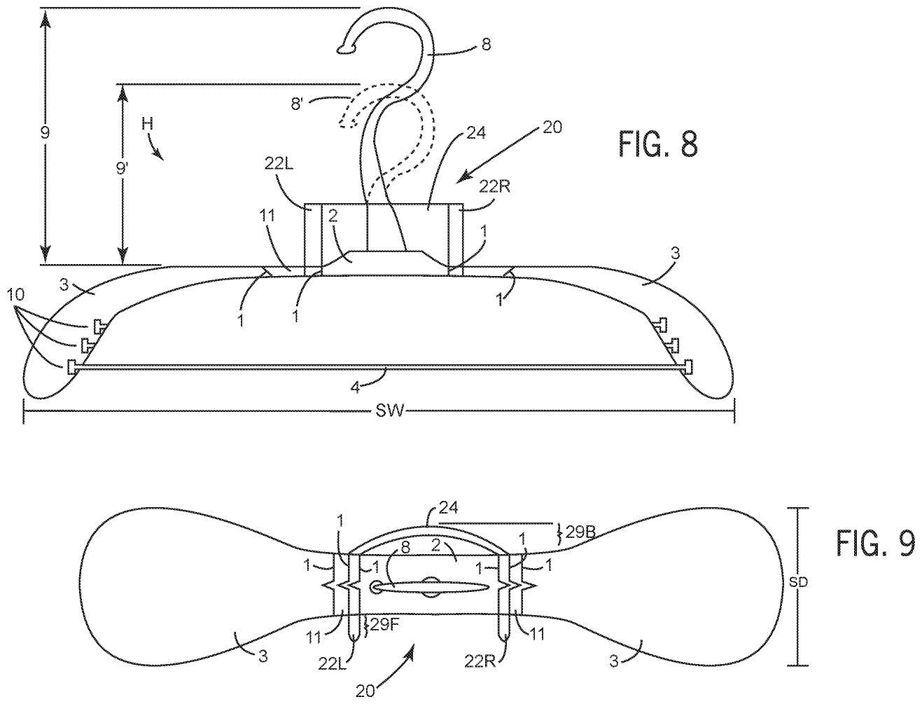

A further embodiment according to the present disclosure is shown in FIGS. 2 and 3, whereby the hanger neck 2 is coupled to the hanger shoulders 3 by multiple neck joints 1. In some embodiments, which are discussed further below, additional elements are incorporated between the hanger neck 2 and the hanger shoulders 3, such as portions of a collar system 20 (FIG. 8) discussed below. It should be recognized that through the selection of different sized spanners 11, the clothing hanger H is customizable to provide the necessary shoulder width SW, as previously discussed. In addition to depicting the modularity provided by the interchangeable, pre-fabricated components, (including the spanners 11), FIG. 3 depicts the selection of an appropriate hanger shoulder 3 having the shoulder width SW and/or shoulder depth SD0 required for the consumer and/or garment. For example, the hanger shoulders 3 for a male or adult consumer may have a greater shoulder width SW and/or shoulder depth SD0 than that of a female or juvenile consumer, respectively. Likewise, the selection of a hanger shoulder 3 for an overcoat versus for a t-shirt, which may further be distinguished from a hanger designed for only hanging pants. Within shirts, the respective collar system 20 (discussed below) will also vary, such as a t-shirt having a crew neck that requires very little support, versus a dress shirt having a collar that requires taller, more substantial support. Consideration of other contours is also anticipated in all three dimensions, including the degree of slope transitioning between points along the hanger H.

The embodiment of FIG. 2 further shows the modularity of adding a customized pants bar 4, which in the present embodiment is coupled to the hanger shoulders 3 at pants bar joints 10 in a press-fit arrangement. Press-fit covers or plugs to improve the aesthetics and also further prevent decoupling of the pants bar 4 are also anticipated (not shown).

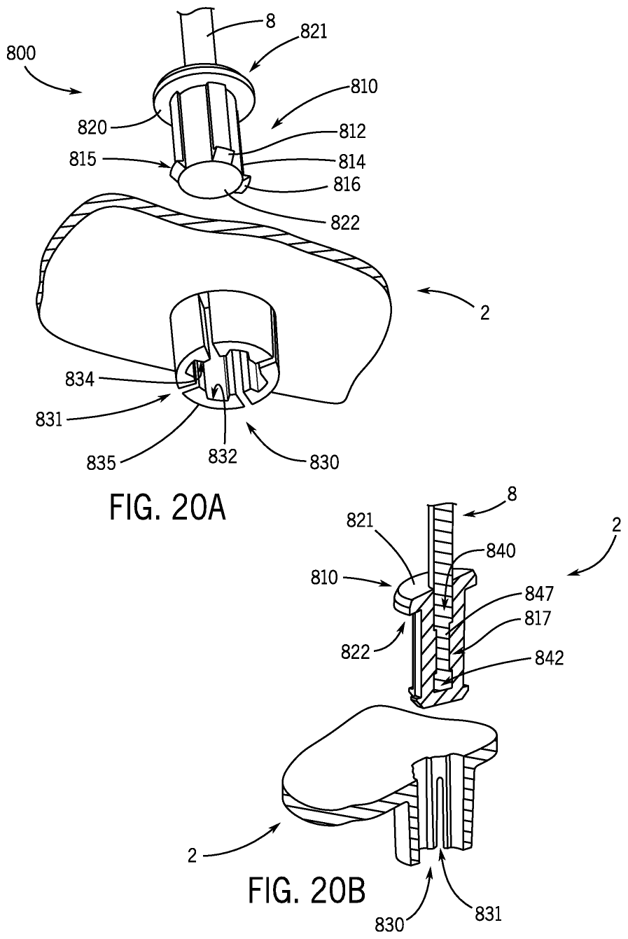

As discussed above, some embodiments are anticipated in which custom-selected or manufactured modular components are assembled entirely by the consumer, along with others in which assemble is at least in part by the manufacturer. In situations in which some portion of the assembly is performed for the user, other portions of the assembly, and/or further accessories may nonetheless be added by the consumer. For example, the consumer may receive a custom hanger H having the hanger neck 2, bar hook 8, hanger shoulders 3, and pants bar 4 already assembled, but be enabled to further adjust or configure the hanger H with accessories 5, such as pegs, dials, or padding fixtures. This type of process may facilitate more efficient shipping (i.e., allowing a smaller package if the consumer adds the bar hook 8, pegs, or other accessories upon receipt), and also allows fine-tuning ad hoc or over time. Additional details for an exemplary accessory anchor system 800 is provided below and shown in FIGS. 20A-B. In the embodiment shown in FIG. 2, receivers 830 (FIGS. 20A-B) for three accessory anchor systems 800 are shown, allowing for symmetrical accessories to be modularly accepted on either side of a bar hook 8, for example. However, it should be recognized that in other embodiments, such as shown in FIG. 14B, other numbers of accessory anchor systems 800, and other positions thereof, are also anticipated by the present disclosure.

Through the methods and systems of the present disclosure, which are discussed further below, a blueprint is formed for the creation of the customized clothing hanger. In certain embodiments, the blueprint includes the selection of particular pre-fabricated components among available, predetermined selections. For example, spanners 11 may be available in a variety of lengths, whereby the blueprint would assign the particular spanner 11 to incorporate when coupling the hanger neck 2 to the hanger shoulders 3. In further embodiments, one or more elements of the hanger H are custom made to the specifications of the consumer and/or the garment, which may further include producing the one or more components through such technologies as 3-D printing. To continue the previous example, a fully-customized clothing hanger H may include the production of a custom-sized spanner 11, rather than a mere selection among a plurality of predetermined sizes. In further embodiments still, the entire hanger H may be comprised of custom-made components (whether separately produced and later coupled, or integrally formed), which as previously stated may be created through 3-D printing.

It should be recognized that other steps for the creation of a clothing hanger H according to the blueprint produced by the presently disclosed systems and methods are also anticipated, including specific instructions for milling, molding, and the like.

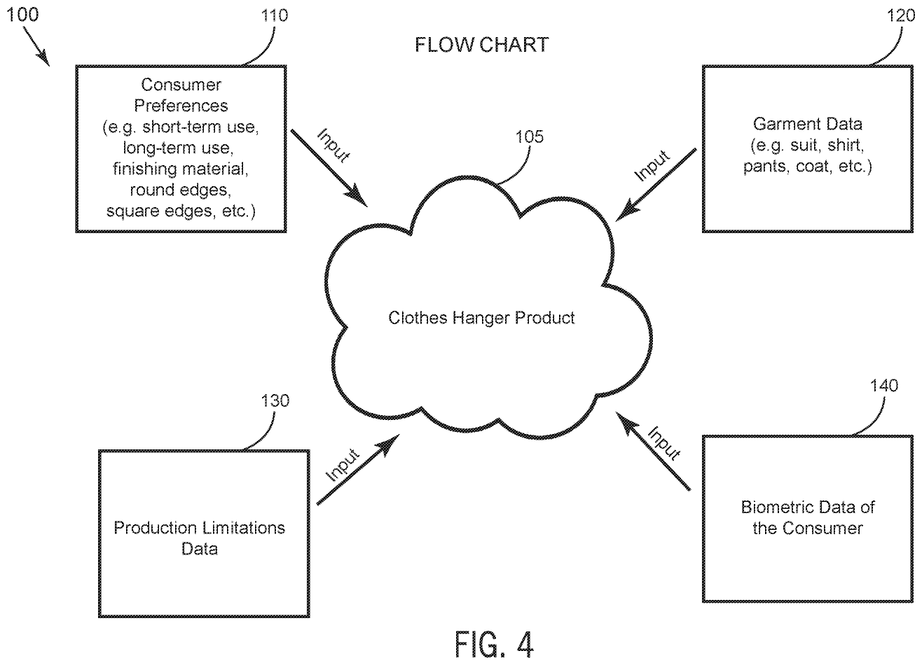

FIGS. 4-6 depict exemplary processes for producing a customized clothing hanger H according to the present disclosure. As shown in the method 100 of FIG. 4, the final clothes hanger product 105 may be produced through inputs from a variety of sources. Exemplary inputs includes consumer preferences 110, such as whether the clothes hanger product 105 will be used for short-term use or long-term use, what type of finishing materials should be used, whether the product will have round edges, square edges, or other geometric features, and other stylistic choices and preferences of the consumer. Additional inputs may include garment data 120, which includes not only the type of garment (i.e. a 3-piece suit versus a shirt, pants, or coat), as well as the length, width, thickness, and material weight of such a garment. The stretch characteristics and durability for a particular type of garment materials may also be considered by the software (discussed below), including in combination with the garment's dimensions. In certain embodiments, the clothes hanger product 105 is developed solely for an existing garment, thereby not requiring biometric data for the particular consumer. In other embodiments, biometric data of the consumer 140 is provided as an input to the clothes hanger product 105, such as when both the construction the garment and the constructions of the custom hanger H will occur together, whereby both are custom tailored to the consumer.

Other inputs are also anticipated for incorporation in the production of a clothes hanger product 105, including production limitations data 130. Exemplary production limitations data 130 includes minimum and maximum dimensions (and tolerating) for a given material to ensure that the final clothes hanger product 105 is within a predetermined weight limit, having predetermined strength characteristics, that different selected components will work together, and that the clothes hanger product 105 will have the stability and strength necessary for a quality build.

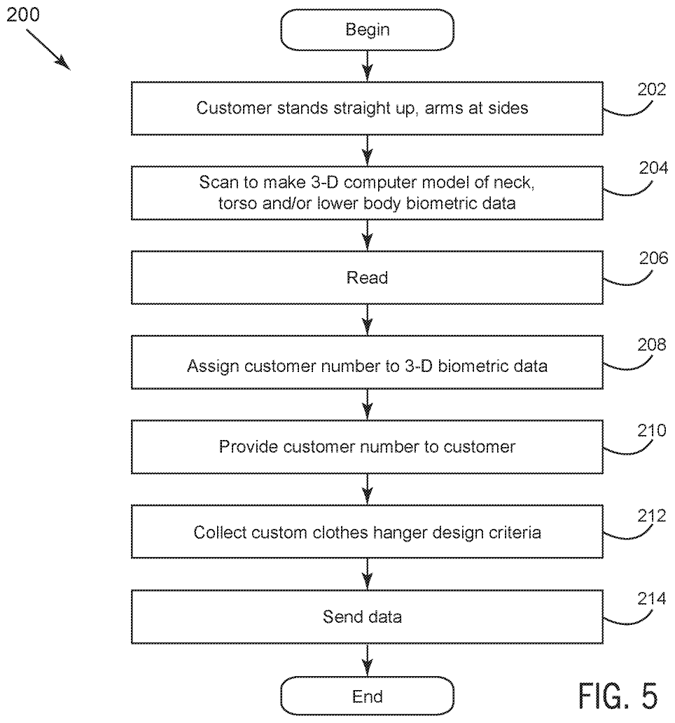

The method 200 shown in FIG. 5 depicts one embodiment for acquiring biometric data of the consumer 140 to be incorporated in the clothes hanger product 105. The method 200 begins with the customer standing straight up, with arms at their sides in step 202. A 3-D camera is used to scan and make 3-D models of the neck, torso and/or lower body biometric data in step 204, depending upon the garment and clothes hanger product 105 to be created. It should be recognized that entry of manual measurement is also anticipated. This information is then read in step 206 by the system 400, which is discussed further below. In certain embodiments, a customer number is assigned to the 3-D biometric data 208 for the purposes of saving this data for future use. In particular, this customer number can be provided to the customer in step 210 for use in the creation of further clothes hanger products 105 in the future. Design criteria for the custom clothes hanger 105 is then collected in step 212, which may include the consumer preferences 110, garment data 120, and product limitations data 130 previously discussed. The design criteria collected in step 212 may further include parameters, such as engraved branding, logos, or other stylistic or informative design features for a consumer, producer of the garment, the producer of the clothes hanger product 105. This data is then compiled and sent for processing in step 214.

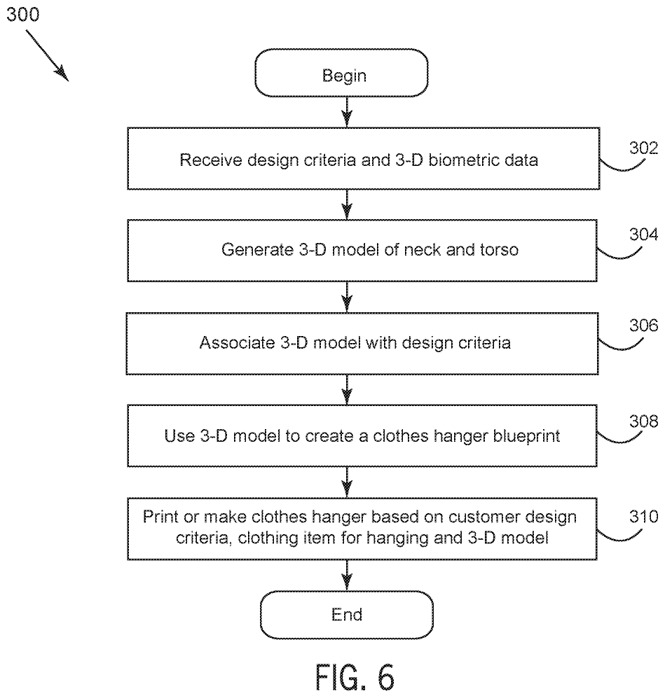

The method 300 of FIG. 6 depicts an embodiment continuing the process after method 200. As shown, the data previously sent in step 214 is received, along with 3-D data and/or biometric data in step 302. In step 304, a 3-D model is generated for the neck, torso, and/or lower body, depending upon the garment in question. A 3-D model is then associated with the design criteria in step 306, which may be based on existing hanger pattern data, such as baseline templates for a given garment, size category, or other classification of consumer or garments. The method 300 then includes using the 3-D model to create a clothes hanger blueprint in step 308, which can be used in step 310 to make or print the clothes hanger based on the consumer designed criteria, garment, and/or 3-D model. As previously discussed, this may include 3-D printing of one or more elements of the clothes hanger product, milling instructions for metal or wooden materials, or schematics for the production of a custom mold for producing a clothes hanger product of plastic or other materials, for example.

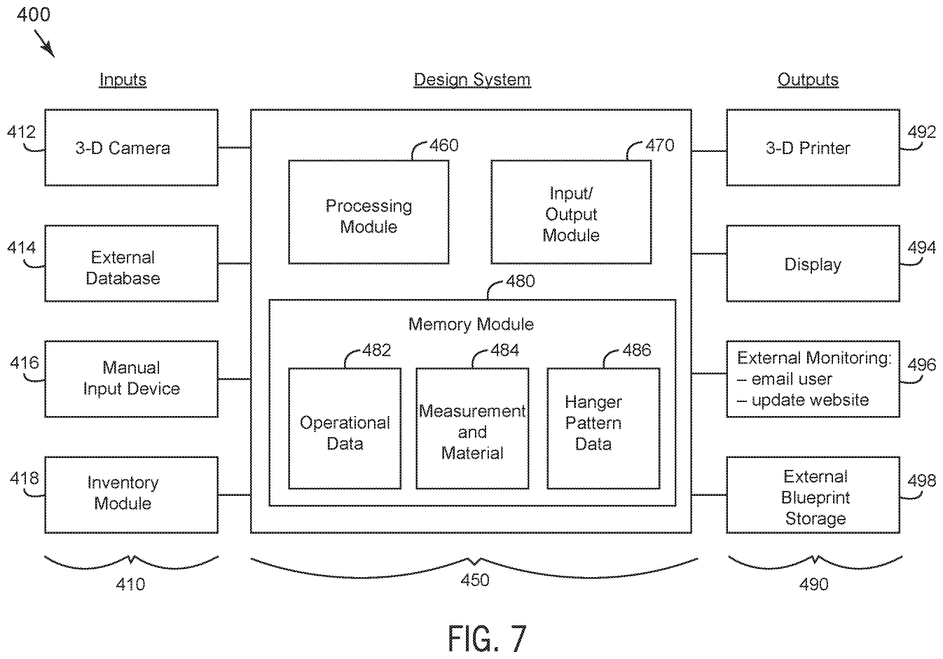

FIG. 7 introduces an exemplary system 400 for carrying out the methods previously discussed to make a customized clothing hanger H according to the present disclosure. The system 400 includes inputs 410 that are received by the design system 450 to generate outputs 490. Exemplary inputs 410 for the system 400 include a 3-D camera 412, or an external database 414, which for example may include saved biometric data for a given consumer, exact or typical data for a given garment, size of garment, material type, and the like, or other data for consideration. Inputs 410 may further include a manual input device 416, which among other options may include a keyboard and/or mouse for manually manipulating existing or adding new inputs 410 to the design system 450. For example, the manual input device 416 may be used to create personalized messages to be engraved, embossed, or molded within one or more components of the completed hanger, such as the initials of the consumer or a personalized message for a gift recipient. In certain embodiments, the inputs 410 further include an inventory module 418 that incorporates the availability of one or more materials for construction of the custom clothes hanger H, including expenses and lead times, for consideration within the design system 450.

In the embodiment shown, the design system 450 includes a processing module 460 that communicates with the inputs 410 via an input/output module 470. The input/output module 470 further communicates with outputs 490, which are discussed further below. The design system 450 further includes a memory module 480 provided in communication with the processing module 460. The memory module 480 includes operation data 482, which in certain embodiments controls the inputs 410, such as an imaging device such as the 3-D camera 412. The operational data 482 may also control outputs 490, such as a 3-D printer 492. However, it should be recognized that the inputs 410 and/or outputs 490 may also be controlled in accordance with operational data stored within these elements, whether in addition to or as an alternative to that stored within the memory module 480.

The memory module 480 further includes storage of the measurement and material data 484, such as that provided as the inputs shown in FIG. 4. Moreover, the memory module 480 further includes hanger pattern and blueprint generator program 486. As previously discussed, this may include baseline templates for various sizes, materials, and garment types to be modified by the inputs 410 for the development of a custom hanger. The hanger pattern and blueprint generator 486 may also include the particular options and dimensions of modular components available to be coupled together for the creation of a clothes hanger in embodiments in which a fully-customized clothing hanger is not requested.

The processing module 460 communicates with the memory module 480 to execute the software contained within the hanger pattern/blueprint generator 486 to create a customized blueprint for a customized clothing hanger H based on the inputs 410. As previously discussed, the software creates this custom blueprint based on requests and interactions between the inputs 410, including but not limited to consumer sizing, fabric dimensions and weight (which also varies by dimension), fabric durability and stretch profile, the selection of materials, garment details, accessories selected, available pre-fabricated components versus a partially or fully customized product, and the like. Moreover, the software incorporates a series of predetermined limits such that inadvisable options or non-compatible selections cannot be made, such as selecting weak materials for the creation of an overcoat hanger, positioning the pants bar 4 in a position that precludes an appropriate shoulder width SW, or other conflicting configurations. These predetermined limits may result in a warning that can be overridden (SP), suggestions for solutions, or automatic correction to meet all minimum needs, for example.

The design system 450 further communicates with various outputs 490, which as previously discussed may include a 3-D printer 492 for creating a clothes hanger in accordance with an outputted blueprint. Additional outputs 490 may include a display 494, which may be further manipulated by inputs 410, such as through the manual input device 416. Additional outputs 490 include external monitoring 496, such as mechanisms for emailing the consumer, such as with status updates, or updating a website for tracking the progress of the process remotely. Exemplary outputs 490 further include external blueprint storage 498 for storing the blueprints developed in the design system 450 for the later use. For example, the external blueprint storage 498 may store the particular blueprints for a given consumer for a particular garment, such as a standard dress shirt, to be used for the production of additional custom clothing hangers in the future without the need for providing new inputs 410.

FIGS. 8 and 9 depict an alternative embodiment according to the present disclosure, particularly one incorporating a collar system 20 within the hanger H. As previously discussed, certain embodiments incorporate the collar system 20 between the hanger neck 2 and the hanger shoulder 3 in a configurable manner, such that the appropriate collar system 20 may be particularly selected based on the dimensions of the user. In other embodiments, the collar system 20 may be permanently incorporated into the hanger H using one of the manners discussed above.

The collar system 20 includes one or more of collar sides 22L, 22R, and a collar back 24, which may be unitary or provided as separate components. In certain embodiments, the collar sides 22L, 22R extend forward from the hanger neck 2 by a collar front distance 29F. Likewise, the collar back 24 extends rearwardly from the hanger neck 2 by a collar back distance 29B, each shown in FIG. 9. The collar sides 22L, 22R are spaced apart by a collar span CS (FIG. 11), which is selected to correspond to the user and/or a particular garment to be hung on the hanger H.

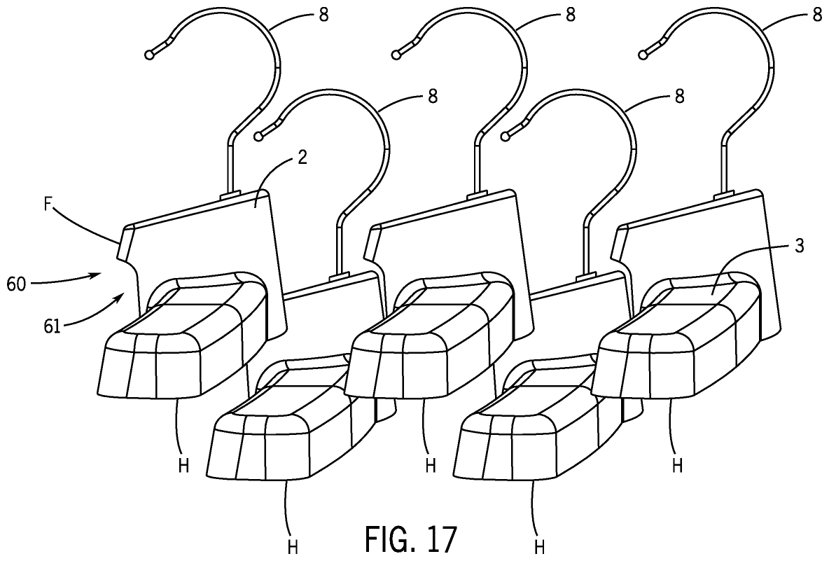

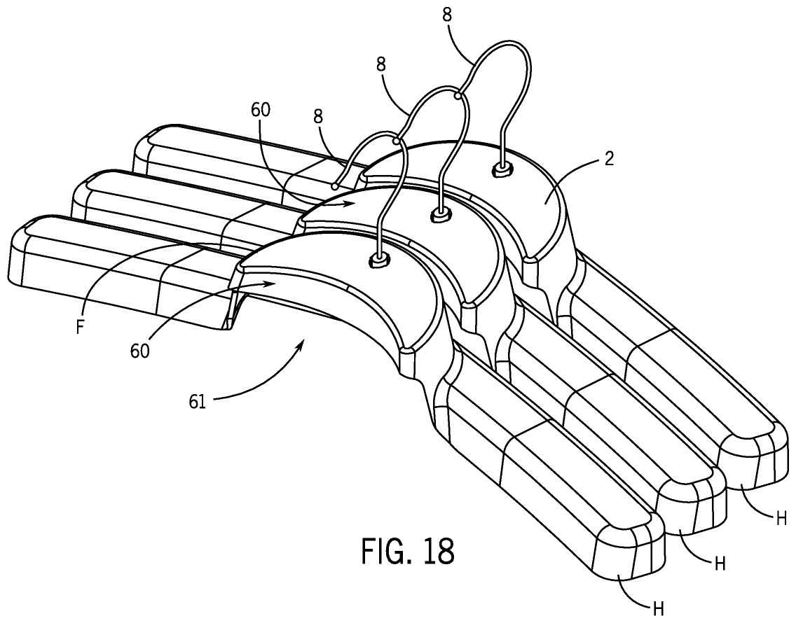

The embodiment of FIGS. 8-9 further depicts an alternative configuration in which the hanger H is configured to be nestable with an adjacent hanger H, as shown in FIG. 17. As shown in FIG. 17, in addition to each of the hangers H including a front cutaway 60 and a front lower cutaway 61 defined within the hanger neck 2 or collar system 20, the hangers H are configured to have two or more different hook heights 9, 9′ (FIG. 8) associated with two or more different hooks 8, 8′. In this manner, the embodiment shown allows hangers H to be nested more closely together by the alternating hanging heights from a rod (not shown), allowing one hanger H to partially overlap the space of another hanger H by virtue of the front cutaway 60 and/or front lower cutaway 61. This is particularly advantageous in circumstances in which the hanger H has a particularly wide width W. However, it should be recognized that the present disclosure further anticipates embodiments providing for nesting of adjacent hangers H having the same heights, once again incorporating a front cutaway 60 and/or front lower cutaway 61, as shown in FIG. 18.

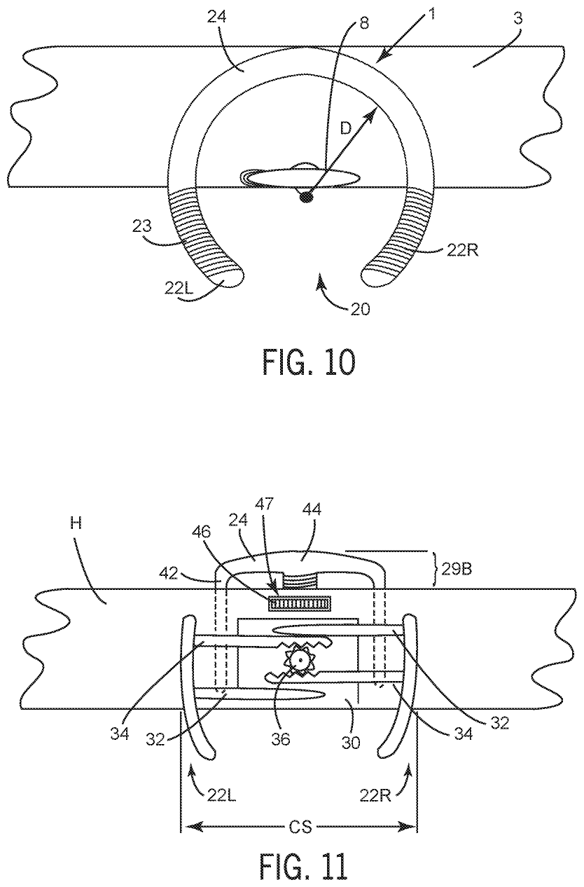

FIGS. 10-12 depict further embodiments of collar systems 20, particularly those incorporating ad-hoc adjustability of the collar system 20 by the user, rather than being fixed to a standard or customized size by the manufacturer. In the embodiment of FIG. 10, portions of each of the collar sides 22L, 22R incorporate a gooseneck region 23, which allows the user to flex or otherwise be manipulated within these portions to meet the desired contours of the garment being hung.

FIG. 11 shows an alternative embodiment providing for adjustability of both the collar sides 22L, 22R, as well as the collar back 24. In this embodiment, the collar sides 22L, 22R are translationally movable by a gear box 30 that incorporates a gear 36. Rotation of the gear 36 causes translation of the collar sides 22L, 22R by virtue of engagement between the gear 36 and sliding geared arms 34 incorporated into each of the collar sides 22L, 22R. Additional sliding support arms 32 are also incorporated and received within support arm recesses 31 defined in the gearbox 30 to provide rigidity and non-rotation of the collar sides 22L, 22R. In certain embodiments, the gear 36 is affixed to a handle (not shown), or in other embodiments to the hook 8 such that rotation of the gear 36 provides adjustability of the collar sides 22L, 22R to provide the desired collar span CS. Similarly, the embodiment shown depicts adjustability for the collar back 24 by rotation of a gear 36 received within a gear recess 37 in the hanger H. Rotation of the gear 36 causes translational movement of the hanger back 24 by engagement with a sliding geared arm 34 provided therewith. In the same manner as previously discussed, the collar back 24 may be outfitted with sliding support arms 42 received within support arm recesses 41 defined within the hanger H to provide non-rotation and further rigidity of the collar back 24 with respect to the remainder of the hanger H.

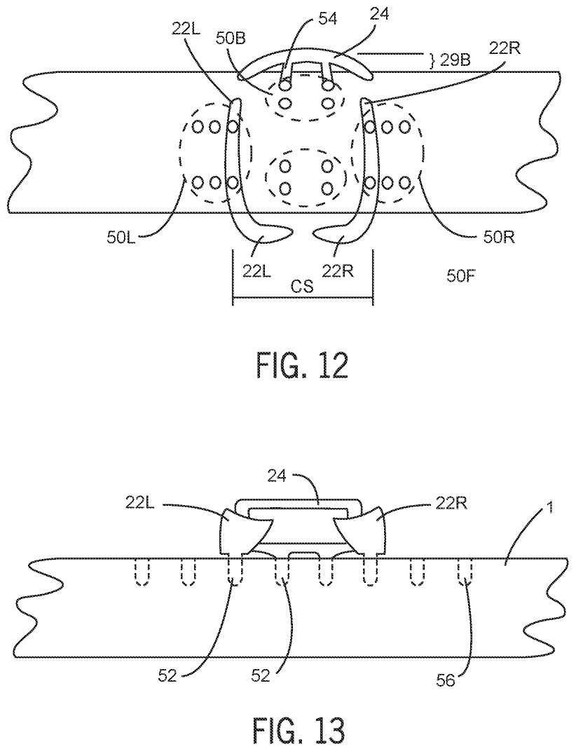

FIGS. 12 and 13 depict a further embodiment providing adjustability of collar sides 22L, 22R, a collar back 24, and optionally a collar front (not shown). Each of these portions of the collar system 20 has a corresponding fixation region 50L, 50R, 50F, 50B in which support legs 52 may be fitted within support leg recesses 56 defined therein. The support legs 52 and support leg recesses 56 in certain embodiments utilizes the standardized accessory anchor system 800 discussed below. In certain cases, such as is shown with respect to the collar back 24, a further offset arm 54 is provided to allow for adjustability or further offset with respect to the collar back distance 29B, for example. In this manner, a standard or one of a number of standard sizes may be provided to a user for each of the elements of the collar system 20, but nonetheless enable the user to adjust the collar span CS, collar back distance 29B, and collar front distance 29F (see FIG. 9) (such as with use of a collar front, not shown) through selection of engagement between the support legs 52 and the support leg recesses 56 defined within the hanger H.

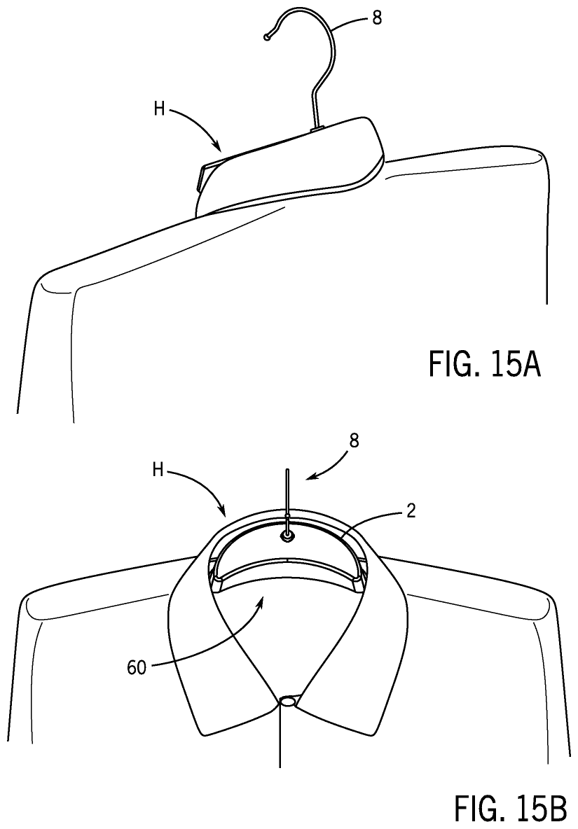

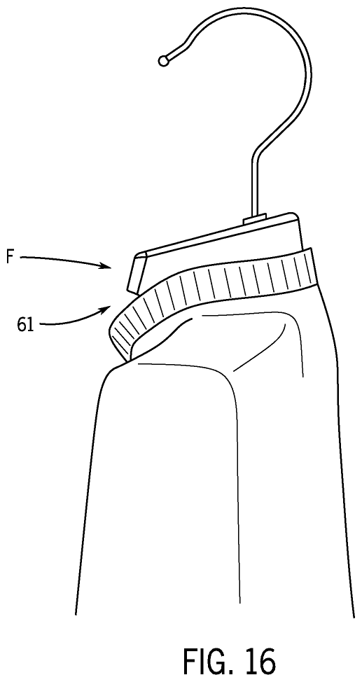

FIGS. 14A-16 depict further exemplary embodiments of hangers H according to the present disclosure. As shown, each of the hangers H may be configured to have front cutaway 60 and/or front lower cutaway 61 for the purposes of nesting and/or material reduction. Likewise, the Figs. depict different applications and configurations for the hangers H depending on the particular garment to be hung, including dress shirts, polos, and crewneck T-shirts.

In certain embodiments, as exemplified in FIG. 14A, the hanger H is also configured to optionally receive attachments to the hanger shoulder 3, such as to add depth, height, width, and/or texture (not to mention other customization choices, such as color and the like). In the embodiment shown, the shoulder addition 3′ is a slide-on portion selected to meet the requirements of the user. As shown, the shoulder addition 3′ is a rubberized molded polymer configured to increase the shoulder depth SD0 of the hanger H to an extended shoulder depth SD3 (along with intermediate extended depths SD1, SD2, for example), thereby providing further configuration of the hanger H while using the same underlying hanger shoulder 3. This shoulder addition 3′ may be a single section, may snap together, use adhesives, and/or be coupled to the hanger H through other methods known in the art, for example. It should be recognized that while the hanger H is shown to only have a shoulder addition 3′ on one of the hanger shoulders 3, the opposite hanger shoulder 3 would typically be outfitted with a shoulder addition 3′ as well, which may be a mirror-opposite of that presently shown.

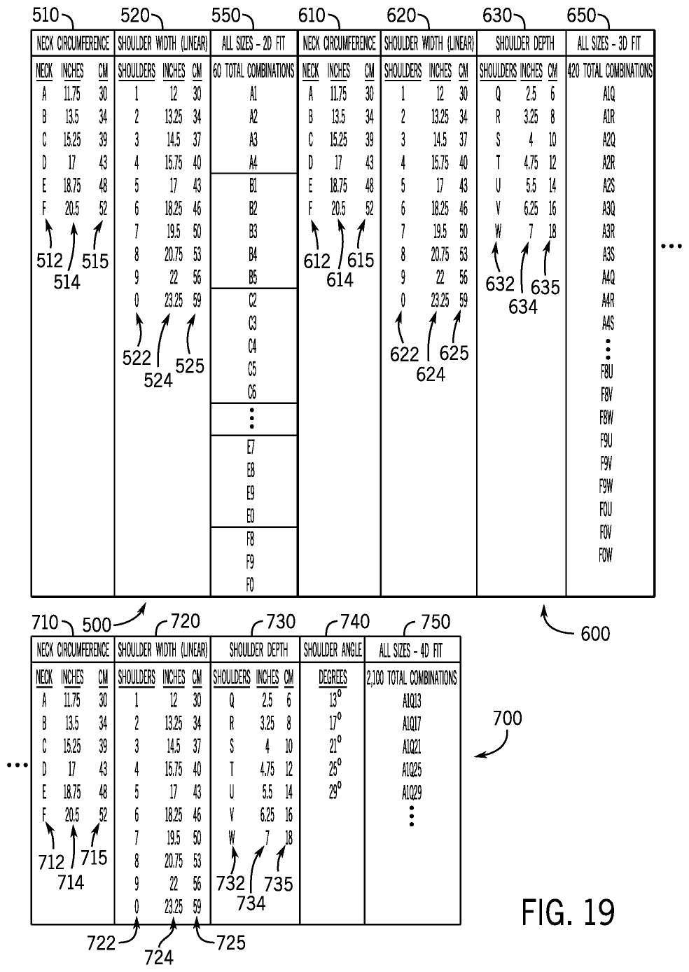

FIG. 19 depicts an exemplary sizing system for configuring a custom hanger H in accordance to the requirements for a particular consumer. Specifically, FIG. 19 shows three exemplary levels of customization: a 2D model 500, a 3D model 600, and a 4D model 700, which correspond to the number of “factors” being customized. Each model 500, 600, 700 includes configuration options based on the consumer's neck circumference 510, 610, 710, as well as shoulder width 520, 620, 720, to together combine into a customized configuration as combinations 550, 650, and 750, respectively. For the neck circumference 510, 610, 710, neck options 512, 612, 712 are provided (i.e., A-F) based on the measured or provided dimensions of the consumer 514/515, 614/615, 714/715. Similarly, shoulder options 522, 622, 722 (i.e., 1-10, shown as 0) are provided based on the measured or provided dimensions of the consumer 524/525, 624/625, 724/725. The actual measurements are suggestive of a typical unisex adult sizing chart (exact sizing subject to change when considering different populations of adults).

Whereas the 2D model 500 is limited to the neck circumference 510 and shoulder width 520 information, the 3D model and 4D model further incorporate a shoulder depth 630, 730 for the consumer, as discussed above. Shoulder depth options 632, 732 (i.e., Q-W) are provided based on measured or provided dimensions of the consumer 634/635, 734/735. This results in a greater number of combinations 650 and 750 for the 3D model 600 and 4D model 700, respectively, relative to the 2D model 500. In the same manner, the 4D model further incorporates data for the consumer's shoulder angle 740, which may be measured as degrees (see angles α in FIG. 14A, for example). In this manner, the total number of combinations 750 for the 4D model 700 are greater than those for the 3D model 600.

It should be recognized that greater or fewer options (such as neck options 512, 612, 712) may also be provided, depending on the level of customization desired by the user in balance with inventory and production costs. It should further be recognized that further “dimensions” may also be incorporated into the standardized sizing models provided in FIG. 19, for example. By introducing the present standardized sizing model, a consumer may easily place orders for hangers H based on measured or approximated dimensions to yield a fully-customized hanger H with convenience and relatively lower cost. In certain embodiments, the standardized sizing model may also vary by demographic or consumer type, for example by: age (i.e., adult versus child), gender, and/or average sizes within a geographic region.

FIGS. 20A and 20B depict one exemplary accessory anchor system 800 for incorporation within a hanger neck 2, and/or within the hanger shoulders 3 for a hanger H according to the present disclosure. The accessory anchor system 800 was previously discussed with the modular insertion of a bar hook 8; however, like accessory anchor systems 800 may be incorporated within the underside of the hanger H or elsewhere as a standardized mechanism for coupling accessories of any type within the standardized modular system presently disclosed. For example, the accessory anchor system 800 may be used to add a belt, scarf, or dress-hanger as required by the consumer.

The accessory anchor system 800 was uniquely developed to provide three essential functions for customized, modular hangers H: (1) 360 degree rotation of an accessory mounted therein, while maintaining the necessary rigidity and strength to securely anchor an accessory thereto; (2) the ability to insert and lock an accessory within the accessory anchor system 800 as a modular addition, easily added by the consumer such that it remains safely coupled thereto; and (3) the ability to reduce the hanger H to a minimal, nestable profile when disassembled to maximize efficiency for shipping and storage, as discussed further above.

In the embodiment shown, the accessory anchor system 800 is configured to couple the bar hook 8 to the hanger, for example at the hanger neck 2, through a coupler 810 received within a receiver 830 therein. The coupler 810 has a cylinder 816 that extends between a top support 821 and a base 822, with a bottom lip 820 resting upon the hanger neck 2. A series of projections 812 having lock tabs 814 with lock surfaces 815 are received within corresponding grooves 832 within the receiver 830. Walls 834 assist in retaining the projections 812 for the couplers 810 within the grooves 832 and expansion cuts 831 are provided to allow the receiver 830 to flex as necessary when the coupler 810 is being inserted therein. In the embodiment shown, the coupler is retained within the receiver 830 when the coupler 810 is fully inserted, whereby the lock surface 815 engages with the base 835 of the receiver 830 to prevent withdrawal of the coupler 810 from the receiver 830. It should be recognized that different configurations, numbers, and positions of projections 812, lock tabs 814, and corresponding grooves 832 are also anticipated.

FIG. 20B further shows one exemplary embodiment for coupling a coupler 810 to a particular accessory, shown here as the bar hook 8. In the embodiment shown, the bar hook 8 has a stem 840 that extends down to a base 842 and defines a lock groove 847 that extends inwardly. The lock groove 847 engages with a corresponding lock projection 817 within the coupler 810 such that when the bar hook 8 is fully inserted into the coupler 810, the lock projection 817 prevents removal of the bar hook 8 via engagement with the lock groove 847 defined therein. It should be recognized that the coupler 810 may be permanently coupled to the accessory during manufacturing, such as through injection molding of parts, for example. However, other mechanisms for coupling the accessory, such as bar hook 8, to the coupler 810 are also known, such as through the use of similar structures to the projections 812 and lock tabs 814 engaging the coupler 810 to the receiver 830. It should further be recognized that in the embodiment shown, since rotation is prevented between the coupler 810 and the receiver 830 by virtue of the grooves 832 defined therein, rotation of the accessory (in situations in which rotation is provided, such as with a bar hook 8) are provided by rotation between the bar hook 8 and the coupler 810.

In the above description, certain terms have been used for brevity, clarity, and understanding. No unnecessary limitations are to be inferred therefrom beyond the requirement of the prior art because such terms are used for descriptive purposes and are intended to be broadly construed. The different assemblies described herein may be used alone or in combination with other devices. It is to be expected that various equivalents, alternatives and modifications are possible within the scope of any appended claims.

1. A method for creating a customized clothing hanger, the method comprising:
receiving garment data relating to a garment to be hung on the hanger;
receiving sizing data relating to a consumer, wherein the garment is wearable by the consumer; developing a hanger blueprint based on the garment data and the sizing data; and creating the hanger according to the hanger blueprint.

2. The method according to claim 1, wherein the sizing data includes at least one of a consumer neck size and a consumer shoulder width for the consumer.

3. The method according to claim 2, wherein the hanger has a hanger neck size and a hanger shoulder size, and wherein the hanger is created such that at least one of the hanger neck size and the hanger shoulder size corresponds to the consumer neck size and the consumer hanger shoulder size, respectively.

4. The method according to claim 1, wherein the clothing hanger is created by assembling modular components.

5. The method according to claim 4, wherein at least one of the modular components is pre-fabricated prior to receiving the sizing data relating to the user.

6. The method according to claim 4, wherein at least one of the modular components is produced via 3D printing.

7. The method according to claim 1, wherein at least a portion of the sizing data is received from an imaging device.

8. A system for creating a customized clothing hanger based on requirements of a consumer, the system comprising:
a bar hook configured to hangingly support the hanger;
a hanger neck configured to be coupled to the bar hook; and
hanger shoulders each configured to be coupled to the hanger neck;
wherein the bar hook, the hanger neck, and the hanger shoulders are modular components selected such that when subsequently assembled they form a hanger that meets the requirements of the consumer.

9. The system according to claim 8, wherein the requirements of the consumer include sizing information relating to the consumer, and wherein the modular components are selected such that the hanger when assembled has dimensions corresponding to the sizing information of the consumer.

10. The system according to claim 9, wherein the sizing information includes a shoulder width of the consumer.

11. The system according to claim 9, further comprising a standard sizing chart for selecting one or more of the modular components based on the sizing information of the user.

12. The system according to claim 8, wherein the requirements of the consumer include garment requirements based on a garment to be hung on the hanger.

13. The system according to claim 12, wherein the garment requirements are based in part on a type of material of the garment, and at least one of dimensions, materials, and textures of the hanger shoulders selected varies based upon the type of the material of the garment.

14. The system according to claim 8, further comprising an accessory configured to be coupled to the hanger neck and/or to one or more of the hanger shoulders.

15. The system according to claim 14, wherein the hanger shoulders each define a plurality of pants bar joints, and wherein the accessory is a pants bar configured to be coupled to each of the hanger shoulders via one of the plurality of pants bar joint defined therewith.

16. The system according to claim 14, wherein the accessory is a collar support configured to support a collar of a garment to be hung on the hanger.

17. The system according to claim 16, wherein the collar support is comprised of a left side and a right side defining a collar support width therebetween, and wherein the collar support is adjustable such that the collar support width meets the requirements of the consumer.

18. The system according to claim 8, further comprising a collar support configured to support a collar of a garment to be hung on the hanger, and wherein the collar support extends forward of the hanger shoulders.

19. The system according to claim 8, further comprising spanners each configured to be coupled between the hanger neck and the hanger shoulders, wherein the requirements of the consumer include a shoulder size required between the shoulder hangers when the hanger is assembled, and wherein the hanger meets the requirements of the consumer only when the spanners are coupled between the hanger neck and each of the hanger shoulders.

20. A customized clothing hanger for hanging a garment based on a consumer neck size and a consumer shoulder size of a consumer, the hanger comprising:
a hanger neck, wherein the hanger neck is configured to be coupled to a bar hook for hanging the hanger neck, and wherein the hanger neck defines a cutaway therein such that the hanger is nestable with other like hangers;
two hanger shoulders each extending from to the hanger neck, wherein a hanger shoulder size is defined to span between the two hanger shoulders when coupled to the hanger neck, and wherein the hanger neck and the two hanger shoulders are configured such that the hanger shoulder size corresponds to the consumer shoulder size; and
a collar support extending forward and above the two hanger shoulders and having a left side and a right side, wherein a collar span is defined between the left side and the right side of the collar support, and wherein the collar support is configured such that the collar span corresponds to the consumer neck side.
